(19) United States
(12) Patent Application Publication
(10) Pub. No.: US 2002/0177437 A1
(43) Pub. Date: Nov. 28, 2002

(54) System and method for maintaining a distributed object system

(76) Inventors: David Chesavage, San Diego, CA (US); Mark Parisi, San Diego, CA (US); Katrina Goldsmith, Cardiff by the Sea, CA (US); Amy Mattinson, San Diego, CA (US); David Eames, Poway, CA (US)

Correspondence Address: Sarah Kirkpatrick, Intellectual Property Administration, QUALCOMM Incorporated, 5775 Morehouse Drive, San Diego, CA, 92121-1714, US

(21) Appl. No.: 09/864,417

(22) Filed: May 23, 2001

(51) Int. Cl. H04Q 7/20

(52) U.S. Cl. 455/426; 455/461

(57) ABSTRACT

A system for maintaining a distributed object system using a network. Data objects are maintained at a network controller and are each associated with a data object version sequence number (OVSN), indicating a state, version, or configuration of each data object. When a receiver transmits a message to the network controller, the message includes an OVSN, representing a state, version, or configuration of objects located at the receiver, so the network controller can interpret the message in accordance with the OVSN contained in the message. The network controller may update the receiver's data objects if necessary.

### BACKGROUND OF THE INVENTION

I. Field of the Invention

The invention relates to methods and apparatus for maintaining objects distributed in a system, and more particularly for a communication system.

II. Description of the Related Art

Systems exist for enabling data communication between one or more dispatchers and vehicles located in vast geographical locations. The dispatchers communicate to a central hub and the central hub communicates with the vehicles via wireless signals. The communicated data may include estimated time of arrival (ETA) to a next pickup/drop-off location, a vehicle location, traffic conditions proximate to the vehicle, whom to see at the next pickup/drop-off location, and what items need to be picked up or delivered.

In geographically limited operations, systems may communicate using a cellular wireless network, see for example, U.S. Pat. No. 5,832,394 to Wortham. In the system described in this patent, vehicle location information is periodically transmitted to a dispatcher via a central hub. The vehicle location information is derived from overhead signals on the cellular network. The overhead information is encoded into a voice signal and communicated to the central hub over the cellular network. The system includes a lookup table of system identifications (SID) of authorized cellular networks and also includes a list of numbers to be used in the networks to enable the transmission of location information and possible direct voice communication with the driver.

Ideally, the mobile-based dispatch system would enable extensive data communication between vehicles and a dispatcher. For example, the system may enable the transmission of data representing the estimated time of arrival (ETA) to a next pickup/drop-off location, a vehicle location, traffic conditions proximate to the vehicle, whom to see at the next pickup/drop-off location, and what items to be picked up or delivered.

To limit the costs of a mobile based system, the system may desire to limit the length of data messages between dispatch systems and vehicles when communicating data between the same. In such a system, objects representing different messages, software, or other update information may be distributed between mobile systems and dispatcher. At times, a dispatcher may desire to change the messages that the objects represent. It is desirable to know the status of each object in a mobile system to ensure that all objects in the mobile receiver are current. Particularly when the object represents a message so the message may be properly decoded. Thus, a need exists for methods and apparatus for limiting the length of data messages in such mobile systems.

### SUMMARY OF THE INVENTION

The present invention includes a system for maintaining data objects distributed on a network. The system includes a network controller and a receiver, such as a wireless communication device (WCD). The network controller is coupled to the network and enables data communications including the transmission of a data object update message and a corresponding data object update version sequence number (“OVSN”). The receiver is coupled to the network and enables data communications with the network controller. The receiver includes a memory for storing a data object based on the data object update message and an OVSN. The receiver also includes a processor coupled to the memory and operable to include the last received OVSN in a message to the network controller.

The network controller may also include a memory for storing the data object based on the data object update message and corresponding OVSN transmitted to the receiver. The network controller may increment the OVSN for each data object update message transmitted to the receiver. Each data object may represent an encoded message and have a data object number. The receiver may include the largest received OVSN in a message to the network controller.

The network controller may decode messages from the receiver where the messages reference a data object and include the receiver's OVSN. The network controller may discard messages from the receiver when the receiver's OVSN is less than the last OVSN sent to the receiver.

In one embodiment, each data object represents an encoded message and has a data object number. The receiver transmits the data object number to represent the encoded message in a message to the network controller. The network controller converts a data object number received in a message from the receiver to the corresponding encoded message. The network controller may send data object update messages and corresponding OVSNs to the receiver based on the receiver's OVSN.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is an illustration of a wireless based vehicle-dispatch communication system of the present invention;

FIG. 2 illustrates a mobile communications terminal (“MCT”) of the present invention in functional block diagram format;

FIG. 3 illustrates a network management computer or controller (“NMC”) of the present invention in functional block diagram format;

FIG. 4 illustrates an algorithm for maintaining an object database between a controller and a group of mobile terminals;

FIGS. 5A to 5F are diagrams of message objects that may be used in an embodiment of the present invention; and

FIGS. 6A to 6F are illustrations of object databases located in the NMC and MCT.

### DETAILED DESCRIPTION OF THE PREFERRED EMBODIMENTS

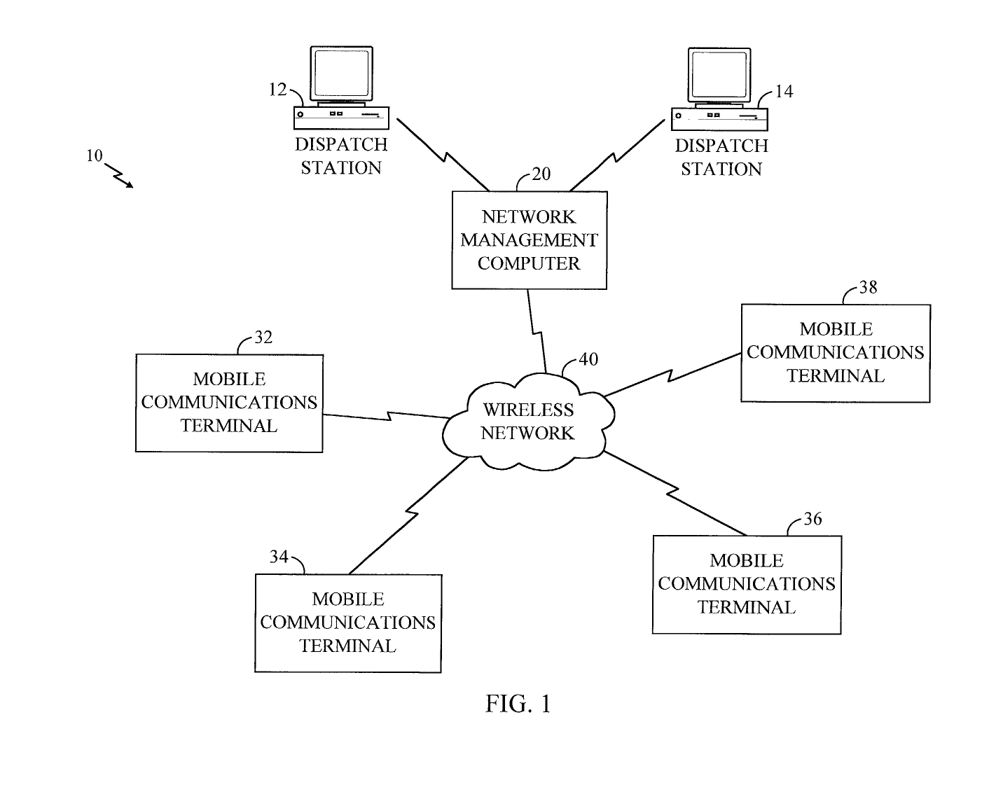

FIG. 1 is a block diagram of a data communication system 10 in which the present invention may be employed. It should be understood that the present invention could also be used in other communication systems (for example, wireline communication systems) and in other applications. The system 10 includes a network management computer or controller (“NMC”) 20 coupled to a plurality of receivers, in this embodiment, mobile communications terminals (“MCT”) 32, 34, 36, and 38 via a wireless network 40.

It should be understood that the term “receiver” is used throughout this specification to denote any device remotely located from NMC 20 which is capable of receiving data from NMC 20 (e.g., computers, digital cameras, data collection devices, etc). As such, the receiver may include both wireless and wireline devices. In addition, the receiver typically includes a transmitter for transmitting data to NMC 20.

The NMC 20 is also coupled to one or more dispatch stations 12 and 14. The NMC 20 may be coupled to the dispatch stations 12 and 14 by dialup connection, Internet connection, or direct connection (local area network). The NMC 20 may be coupled to the wireless network 40 via plain old telephone service (POTS) at a POTS entry point to the wireless network or wirelessly to the network 40. The communication system 10 may be used to track and communicate with a fleet of vehicles. Each MCT is mounted in a vehicle or part of a mobile device optimally geographically located within the operational boundaries of the wireless network 40. Dispatch station 12 and 14 may transceive data between each MCT 32, 34, 36, and 38 via the NMC 20 and the wireless network 40. The data communicated between terminals and stations may include common messages, e.g., the geographical location of the vehicle, estimated time of arrival (“ETA”) to a next drop-off or pick-up site, contact information and items to be delivered or picked up at the next site. Each MCT 32, 34, 36, and 38 may also include voice communication equipment.

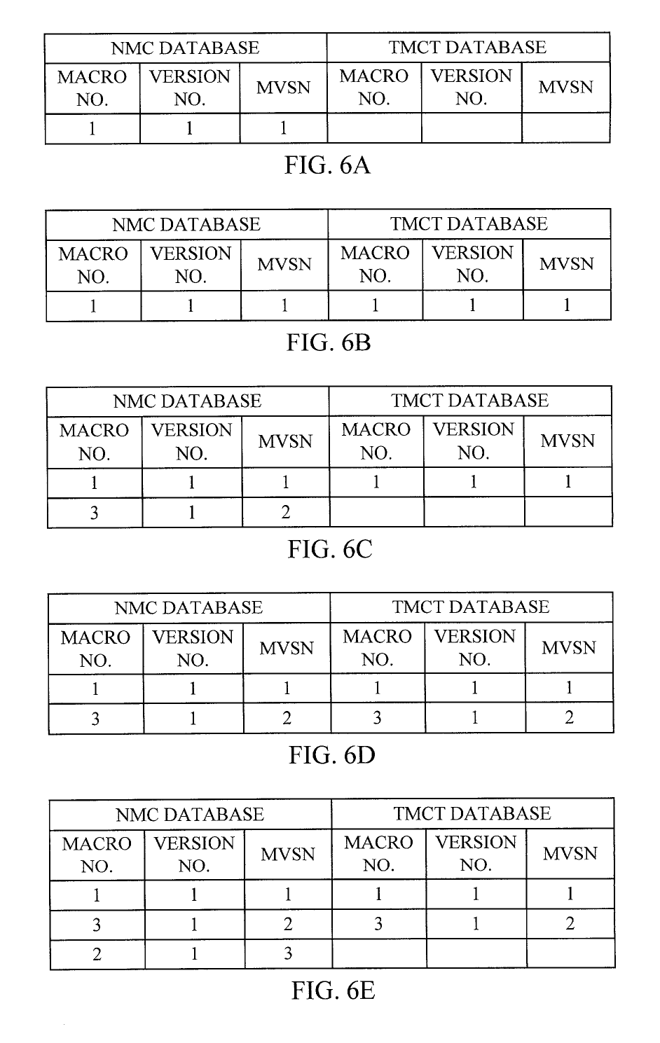

In order to conserve bandwidth and simplify communications between terminals (MCT) and stations, data objects comprising macros may be distributed to each MCT in the network 40. Macros are well-known “templates” used in data communications for reducing the amount of data transmitted over the air. Macros operate by transmitting a macro identifier and fields of information supplied by a vehicle operator or automatically by a computer onboard a vehicle. When communicating such a message only the object or macro number and fields are transmitted between a MCT and dispatch station via the NMC 20. FIGS. 5A to 5F are diagrams of common messages that have been assigned an object or macro number, in particular, 01 to 05. As shown in these figures, there are objects or macros where the underlying message includes fields to be entered (01 to 03 shown in FIGS. 5A to 5D) and objects or macros without fields (04 and 05 shown FIGS. 5E and 5F). Accordingly, in the communication system 10, an object or macro number (with fields where applicable) may be transmitted between a mobile communication terminal (MCT) and a dispatch station. The MCT or dispatch station decodes the underlying message based on the received object or macro number and received fields (if any).

There may be different sets of objects or macros deployed in the system where the object set is application dependent. The NMC 20 maintains an object database having each object set distributed to one or more receivers (MCTs in the exemplary embodiment). Over time, objects (macros) may be revised (i.e., by a dispatch station). In the exemplary embodiment, when an object is modified, the message it represents is modified.

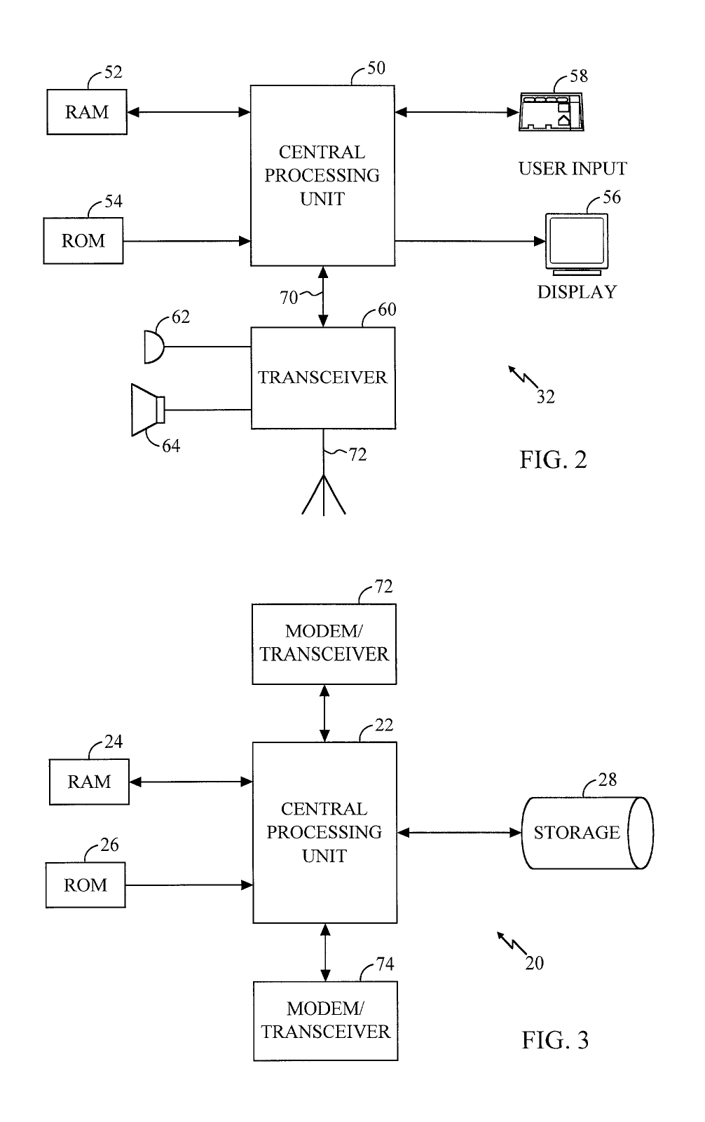

A block diagram of an exemplary MCT 32 capable of use with the present invention is shown in FIG. 2. The MCT 32 includes a central processing unit (“CPU”) 50, a random access memory (“RAM”) 52, a read only memory (“ROM”) 54, a display 56, a user input device 58, a transceiver 60, a microphone 62, a speaker 64, and an antenna 72. The ROM 54 is coupled to the CPU 50 and stores the program instructions to be executed by the CPU 50. The RAM 52 is also coupled to the CPU 50 and stores temporary program data, objects (macros, in the exemplary embodiment) with attributes, and the last received object (macro) version sequence number (“OVSN”). The user-input device 58 may include a keypad, a touch pad screen, a track ball, or other input device. The user employs the input device 58 to navigate through menus, to generate messages using objects (macros), and other functions. The display 56 is an output device such as a CRT, a LCD, or other user perceptible device. The user may employ the display 56 to read decoded messages or other data transmitted from a dispatch station 12 or 14 or other receiver (MCT 32) via the wireless network 40. The CPU 50 may be an Intel™ 80186 processor in one embodiment.

The microphone 62 and speaker 64 may be incorporated in a handset coupled to the transceiver 60. The microphone 62 and speaker 64 may also be more physically separated to enable hands free communication with the user of the MCT 32. In this mode, the transceiver 60 may include voice activation circuitry that may convert voice into data transmitted to the CPU 50 for processing. The data is transmitted to CPU 50 via a serial bus 70.

The transceiver 60 includes an instruction set necessary to communicate data and voice signals over the network 40. In one embodiment, the transceiver 60 supports code division multiple access (“CDMA”) protocols and the wireless network comprises a CDMA based network that supports data and voice signals. The transceiver 60 is coupled to the antenna 72 for communicating signals with the wireless network 40. When a data signal is received by the transceiver 60, the data is transferred to the CPU 50 via the serial bus 70. The data can include additions, deletions, and modifications to the object or macro database and coded messages in the form of objects and attributes (fields) where applicable. The data may also include software updates for the receiver.

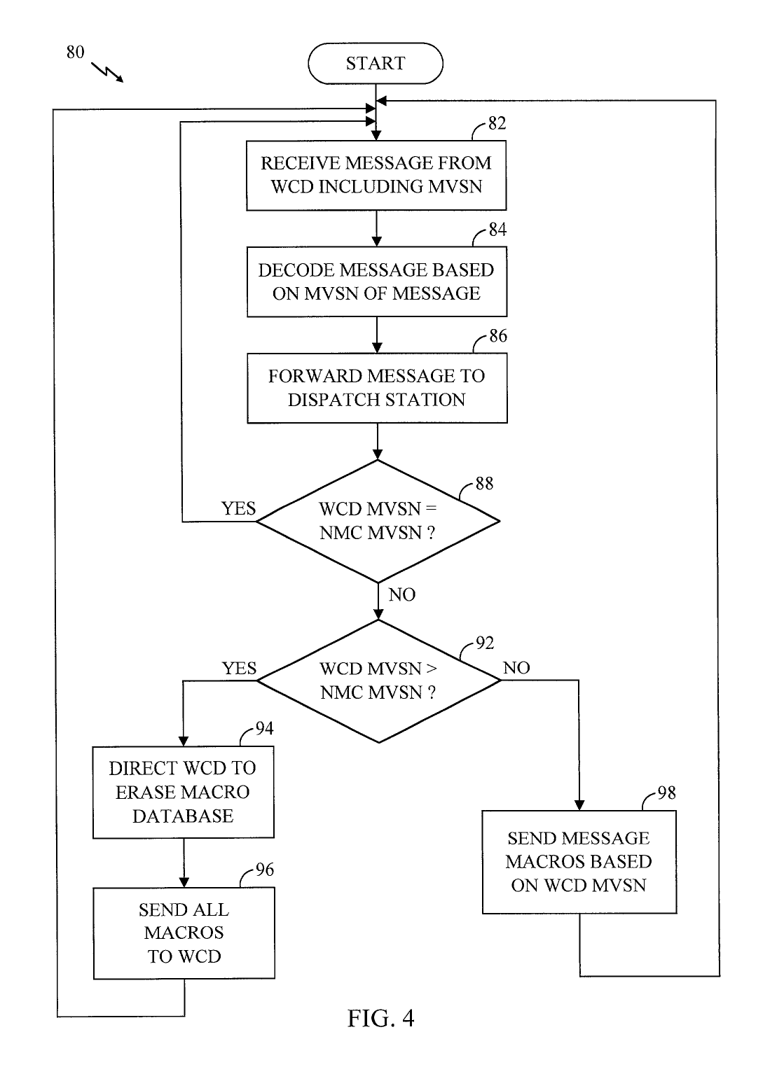

A block diagram of NMC 20 capable of use with the present invention is shown in FIG. 3. The NMC 20 includes a CPU 22, a RAM 24, a ROM 26, a storage unit 28, a first modem/transceiver 72, and a second modem/transceiver 74. The first modem/transceiver 72 couples the NMC 20 to the dispatch station 12 and 14. The modem/transceiver 72 may be an Ethernet modem connecting the NMC to a local network or Internet. The second modem/transceiver 74 couples the NMC 20 to the wireless network 40. The modem/transceiver 74 may again be an Ethernet modem, telephone modem, wireless modem or other communication device that may communicate with the wireless network 40. The CPU 22 directs communications between the first and second modem 72 and 74 for messages between the dispatch terminals 12 and 14 and one or more MCT 32, 34, 36 and 38.

The ROM 26 may store program instructions to be executed by the CPU 22. The RAM 24 may be used to store temporary program information, an object database for message object set, and a receiver (MCT) software database. The storage unit 28 may be any unit capable of data storage and may be used to store the object database for each object set.

Over time a dispatch station may revise message objects and software modules in the receivers (MCTs). Accordingly, the state of the object (macro) and software module database located at a NMC 20 or MCT 32 may vary as objects or software modules are maintained, updated, or reprogrammed for different applications. The receiver may be reprogrammed for a different application by replacing the object database and one or more software modules. In the present invention, the NMC 20 sends object (macro) and software module update messages to the one or more receivers (MCTs) having the same object or software module set (such as a group of MCTs performing similar tasks, e.g., delivery tasks). In order to conserve bandwidth and system resources, the NMC 20 may send unacknowledged object or software module update messages to the one or more receivers. In this embodiment, the NMC 20 presumes that each associated receiver receives and implements each object (macro) or software module update.

In order to quickly determine whether each receiver has the most current object (macro) database i.e., has received and implemented each update, the NMC includes a Macro (set) Version Sequence Number (“MVSN”) with each object (macro) update message for a particular object set. The MVSN is one embodiment of an object update version sequence number (“OVSN”), which is used to generically describe a state, or version, of a configuration of a receiver. In one embodiment, the MVSN for each object (macro) set starts with one and is incremented with each subsequent update to an object (macro) in the set.

In one embodiment, when a receiver receives an object (macro) update with MVSN from the NMC 20 that corresponds to its object set, the receiver first compares the MVSN to last applicable MVSN received. If the difference is not equal to one, the receiver has missed one or more intermediate updates and may send a message to the NMC 20 indicating the last MVSN it received and implemented. Accordingly, the current update may be discarded. Otherwise (when the differential between the last received MVSN and the MVSN associated with the current update is equal to one), the receiver updates the object set database based on the message and changes the MVSN to the one received with the update message. In order to quickly determine whether each receiver has the most current object (macro) database i.e., has received and implemented each update, the NMC includes a Macro (set) Version Sequence Number (“MVSN”) with each object (macro) update message for a particular object set. The MVSN is one embodiment of an object update version sequence number (“OVSN”), which is used to generically describe a state, or version, of a configuration of a receiver. In one embodiment, the MVSN for each object (macro) set starts with one and is incremented with each subsequent update to an object (macro) in the set.

In another embodiment, the receiver does not compare MVSNs to determine whether it has the correct version or configuration as denoted by NMC 20. Rather, the NMC 20 or other entity, such as dispatch station 12, performs this function. In this embodiment, the receiver includes the last received MVSN number in messages transmitted to the NMC 20. Accordingly, the NMC 20 (or other entity) analyzes the receiver's last reported (received and implemented) MVSN based on the object set for the receiver. When the receiver is not current (the receiver's MVSN is not equal to the MVSN for the object set, the NMC 20 may be instructed to retransmit any missing objects/updates, either from a determination made by NMC 20, or by a determination made by another entity. In an embodiment where another entity performs the just-described functionality, NMC 20 forwards a received MVSN number to another entity, such as dispatch station 12. Dispatch station 12 then performs the necessary MVSN determination, and provides NMC 20 instructions in accordance with the determinations (for example, retransmit missing objects).

The NMC 20 may transmit missing objects/updates to the receiver at any time after the determination by NMC 20 or other entity. In addition to determining the confuguration status of a receiver, either the NMC 20 or other entity may process a message accompanying an MVSN. In one embodiment, the NMC 20 does not decode message objects from a receiver having a MVSN not equal to the current MVSN for the object set associated with the receiver. In another embodiment, the NMC may decode a received message object (with attributes if any) based on the receiver's MVSN, i.e., the NMC 20 may have an object database that also varies as a function of the MVSN. In another embodiment, NMC 20 simply provides received messages to another entity, such as dispatch station 12 for processing. Dispatch station 12 may then decode the message, if it is capable of doing so. Otherwise, the message may be discarded and a request sent from dispatch station 12 to NMC 20 to retransmit any necessary object/updates to the receiver so that an up-to-date message may be transmitted.

The just-described process may be used to determine whether a receiver's software module database is current. In order to determine whether each receiver has the most current software modules, i.e., has received and implemented each software update, the NMC may include a Software Version Sequence Number (“SVSN”) with each software update message for a particular software set. In one embodiment, the SVSN for each software module set also starts with one and is incremented with each subsequent update to a software module in the set. When a receiver receives a software module update with a SVSN from the NMC 20 that corresponds to its software module set, the receiver may first compare the SVSN to last applicable SVSN received (and successfully implemented). If the difference is not equal to one, the receiver may have missed one or more intermediate updates. The receiver may send a message to the NMC 20 indicating the last SVSN it received and implemented. Accordingly, the current software update may be discarded. Otherwise (when the differential between the last received SVSN and the SVSN associated with the current software module update is equal to one), the receiver updates the software module database based on the message and changes the SVSN to the one received with the update message. In one embodiment, the receiver also includes the last received SVSN number in messages transmitted to the NMC 20. Accordingly, the NMC 20 may analyze the receiver's last reported (received and implemented) SVSN based on the software module set for the receiver. When the receiver is not current (the receiver's SVSN is not equal to the SVSN for the object set), the NMC 20 may retransmit any missing updates. The NMC 20 may determine which updates the receiver did not implement by noting the receiver's SVSN.

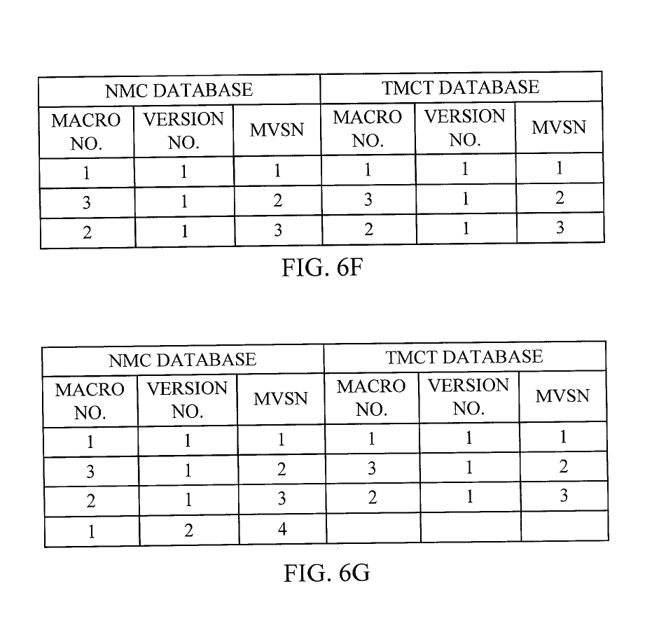

An example of the use of the MVSN in the NMC and MCT is explained in more detail with reference to FIGS. 6A to 6G. In this example it presumed that the object or macro database in the MCT 32 and corresponding object or macro database for the set in the NMC 20 are null to start. Then the NMC 20, via a dispatch station 12 or 14, generates an object or macro for the set corresponding to the object set of the MCT 32. In this example, object or macro 01, version 01 (since it did not exist in the object set before) shown in FIG. 5A is to be added to the corresponding object database in the NMC and MCT. The object is added to the object database of the NMC 20 that corresponds to the object set as shown in FIG. 6A. The MVSN is then incremented to one. Thus, as shown in FIG. 6A, the NMC object set database includes macro 01 with a MVSN equal to 01 (where the counter starts at zero), i.e., the MVSN of the this object database set is one. FIG. 6A also indicates the macro version number (how many times it has been individually updated); this is included only for explanation purposes and is not necessarily part of the NMC database or the MCT database. At this instance, the MVSN for the object database set is 1 and the MCT object database MVSN is zero.

Then, macro 01, version 01 with MVSN 01 is sent to each MCT having the object database set (in another embodiment, the update may be broadcast to all receivers where the receivers discard updates not directed to their object database set). As explained, in one embodiment, the MCT receives the object update with an MVSN and compares the MVSN to the local MVSN. When their difference is one (as in this case), the receiver implements the update (adds macro 01 to the database) and replaces its local MVSN with the received MVSN (with one). As shown in FIG. 6B, macro one (version one) has been added to the receiver's object (macro) database. Accordingly, a user of the receiver can use object (macro) one to send a message having the format shown in FIG. 5A to another receiver or dispatch station via the NMC 20. Then object or macro three (version one), shown in FIG. 5C, is added to the NMC macro database and MCT macro database as shown in FIGS. 6C and 6D. At this point the receiver's MVSN and the corresponding NMC object set database MVSN are equal to two. Object or macro two (version one), shown in FIG. 5B, is added to the MCT macro database and the corresponding NMC macro database as shown in FIGS. 6E and 6F. Then, the MCT MVSN and the corresponding NMC MVSN are equal to 03. Then, an existing object or macro, (object one) is updated to a new version, (version two), as shown in FIG. 5D. The corresponding NMC macro database is updated as shown in FIG. 6G. It is presumed that MCT 32 does not receive the update object message (having MVSN four (04)) due to unknown reasons such as range of MCT to base station or other. Accordingly, the receiver's MVSN for the message object database remains equal to three while the NMC MVSN for the corresponding message object database is equal to four.

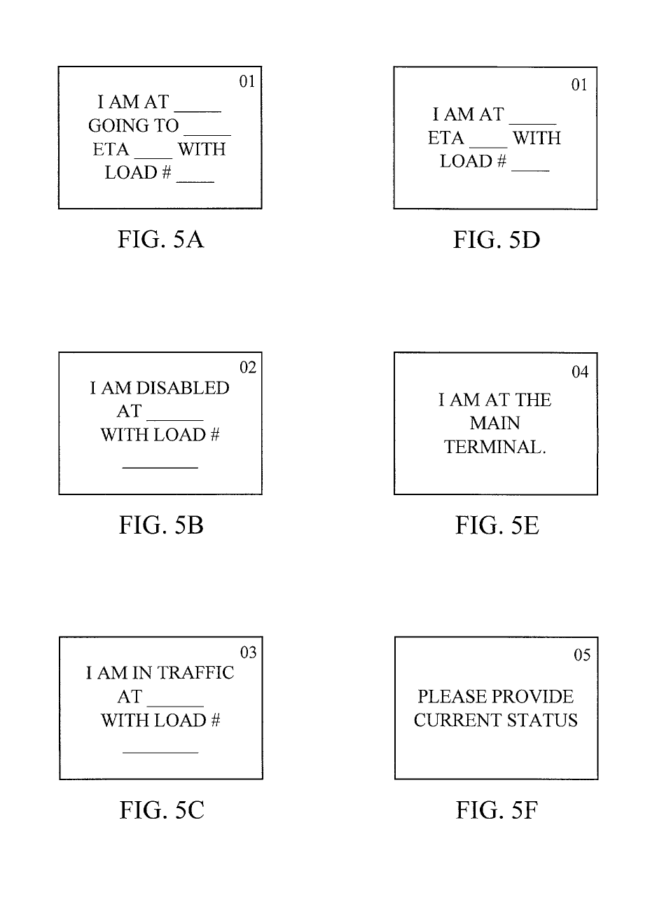

When the receiver 32 next transmits a message (such as status message) to NMC 20 the message may include the receiver's message object database MVSN (in this case equal to three). In one embodiment upon receipt of such a message from the receiver, the NMC 20 may employ the process 80 (shown in FIG. 4) to decode the message and determine the status of the object (macro) message database of the MCT. At step 82, the NMC 20 receives a message from a receiver that includes the receiver's object (macro) message MVSN. In one embodiment the message is decoded based on the receiver's object message MVSN (step 84). Decoding, in one embodiment, refers to translating a macro message into an actual text message. The NMC 20 maintains an object database that varies as a function of object and MVSN (two dimensional database). Accordingly, when the receiver's message includes object or macro one and the receiver's message object database MVSN is three, the NMC 20 decodes the message by locating the version of object one that existed when the MVSN of the object database was three. In this case, NMC 20 will decode the message to object or macro one, version one. In another embodiment, the NMC 20 only maintains the most current versions of the objects or macros for each set. When the NMC receives an encoded object (macro) message for an object set where the receiver's MVSN is not equal to the NMC's MVSN for the object set (step 88), the NMC may discard the message. In another embodiment, the NMC forwards the encoded (macro) message to another entity for processing.

If appropriate, depending on the message, the NMC 20 may forward a decoded message to a dispatch station or another receiver (MCT) (step 86) for processing. At step 88, the NMC 20 (or other entity) compares the receiver's MVSN to the NMC's MVSN for the corresponding object set. When they are equal, the receiver's message object database is current. When they are not equal, NMC 20 may determine whether the receiver's MVSN is greater than the NMC's corresponding MVSN (step 92). When this condition is true, the receiver's message object database may be corrupt or correspond to a different message object database set. In this case, the receiver's message object database may need to be completely replaced. Accordingly, at steps 94 and 96, the NMC 20 may send the receiver an erase object database command and then resend all objects (macros) of the message object database set to the receiver.

Otherwise (when the receiver's MVSN is less than the corresponding NMC object database set MVSN), (step 98) the NMC 20 sends object messages for the missed object updates based on the MVSN differential (in the example, the object update for object one, version two). This process thus enables the NMC 20 to maintain the message object database for each receiver as needed, i.e., when the receiver transmits a message indicating its database is not current. This technique may also be used to maintain other object databases on receivers such as a software module database.

The previous description of the preferred embodiments is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

While this invention has been described in terms of a best mode for achieving this invention's objectives, it will be appreciated by those skilled in the art that variations may be accomplished in view of these teachings without deviating from the spirit or scope of the present invention. For example, the present invention may be implemented using any combination of computer programming software, firmware or hardware. As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code on a network for remote execution.

We claim:

1. A system for maintaining data objects distributed on a network, comprising:
a network controller coupled to the network and operable to enable data communications including the transmission of a data object update message and a corresponding data object update version sequence number (“OVSN”); and
a receiver coupled to the network and operable to enable data communications with the network controller, the receiver including a memory for storing a data object based on the data object update message and the OVSN and a processor coupled to the memory and operable to include a last received OVSN in a message to the network controller.

2. The system of claim 1, wherein the network controller includes a memory for storing the data object based on the data object update message transmitted to the receiver and a corresponding OVSN.

3. The system of claim 1, wherein the network controller includes a memory for storing the data object based on the data object update message transmitted to a plurality of receivers that includes the receiver and a corresponding OVSN.

4. The system of claim 2, wherein the network controller is further operable to increment the OVSN for each data object update message transmitted to the receiver.

5. The system of claim 1, wherein each data object represents an encoded message.

6. The system of claim 4, wherein the receiver is further operable to include the latest received OVSN in a message to the network controller.

7. The system of claim 6, wherein the receiver is a wireless communication device and the network is a wireless network.

8. The system of claim 6, wherein the network controller is further operable to decode the message from the receiver, where the message references a data object and includes the receiver's OVSN.

9. The system of claim 4, wherein the network controller discards messages from the receiver when the receiver's OVSN is less than the last OVSN sent to the receiver.

10. The system of claim 9, wherein each data object represents a macro message and has a data object version number.

11. The system of claim 10, wherein the receiver is further operable to transmit the data object version number to represent the version of the encoded message in a message to the network controller.

12. The system of claim 11, wherein the network controller is further operable to decode the encoded message based on the data object version number received from said receiver.

13. The system of claim 11, wherein the network controller is further operable to send data object update messages and corresponding OVSNs to the receiver based on the OVSN included in a message from the receiver.

14. A receiver for communicating data signals using a network, comprising:
a transceiver coupled to the network and operable to receive data communications;
a memory coupled to the transceiver for storing data objects and data object message version sequence numbers (OVSN) transmitted from a network controller in a data communication to the receiver; and
a processor coupled to the memory and transceiver and operable to include the last received OVSN in a message to the network controller.

15. The mobile communications terminal of claim 14, wherein the processor is further operable to include the largest received OVSN in a message to the network controller.

16. The mobile communications terminal of claim 14, wherein each data object represents an encoded message and has a data object number.

17. The mobile communications terminal of claim 16, wherein the processor is further operable to use the data object number in a message to the network controller to indentify a version of the encoded message.

18. A method of maintaining a distributed object system using a network, comprising the steps of:
receiving a data object update message with a data object update version sequence number (OVSN) from a network controller;
storing data objects based on the data object update message and said OVSN; and
transmitting the last received OVSN in a subsequent message to a network controller.

19. The method of claim 18, wherein each of said data objects represent an encoded message and has a data object version number.

20. A method of maintaining a distributed object system using a network, comprising the steps of:
receiving a message from a receiver, said message comprising an object version sequence number (OVSN), said OVSN representing a first state of a data object relating to said receiver;
comparing said OVSN with a local OVSN, said local OVSN representing a second state of said data object;
processing said message in a first manner if said OVSN is equal to said local OVSN; and
processing said message in a second manner if said OVSN is not equal to said local OVSN.

21. The method of claim 20, wherein the step of procesing said message in said first manner comprises the step of processing said message in accordance with said OVSN.

22. The method of claim 21, wherein said message comprises a macro message and the step of processing said message comprises the step of decoding said macro message.

23. The method of claim 22, further comprising the step of providing said decoded macro message to a dispatch station.

24. The method of claim 20, wherein the step of processing said message in said second manner comprises the step of ignoring said message.

25. The method of claim 20, wherein the step of processing said message in said second manner comprises the step of transmitting a data object update message with said local OVSN.

26. The method of claim 20, wherein the step of processing said message in said second manner comprises the step of transmitting all data objects to said receiver.

27. The method of claim 20, wherein the step of comparing said OVSN with said local OVSN is performed at a network controller.

28. The method of claim 20, wherein the step of comparing said OVSN with said local OVSN is performed at a dispatch station.

29. The method of claim 20, wherein the step of processing said message in said first manner comprises the step of providing said message to a dispatch station.

30. The method of claim 20, wherein the step of processing said message in said second manner comprises the step of providing said message to a dispatch station.

31. A network controller for maintaining a distributed object system using a network, said network controller comprising:
a database for storing a data object and a corresponding data object version sequence number (OVSN);
a transceiver for sending a data object update message and a corresponding OVSN, said OVSN representing a state of said data object and for receiving a message from a remote receiver, said message comprising an OVSN representing a state of a data object associated with said receiver; and
a processor for comparing said received OVSN with said OVSN stored within said database, and further for processing said message received from said remote receiver in a first manner if said received OVSN matches said OVSN stored within said database and for processing said message received from said remote receiver in a second manner if said received OVSN does not match said OVSN stored within said database.
